(19) United States
(12) Patent Application Publication
(10) Pub. No.: US 2025/0173186 A1
(43) Pub. Date: May 29, 2025

(54) METHOD AND DEVICE FOR RESOURCE ALLOCATION OF CLOUD PLATFORM

(71) Applicant: Fulian Precision Electronics (Tianjin) Co., LTD., Tianjin (CN)

(72) Inventor: CHENG-YU WANG, New Taipei (TW)

(21) Appl. No.: 18/898,978

(22) Filed: Sep. 27, 2024

(30) Foreign Application Priority Data
Nov. 29, 2023 (CN) 202311616023.0

(51) Int. Cl. G06F 9/50

(52) U.S. Cl. CPC G06F 9/5027

(57) ABSTRACT

A method for resource allocation of a cloud platform is provided. The method comprises: collecting an initial hardware parameter of an electronic device based on the electronic device accessing the cloud platform, vectorizing the initial hardware parameter to obtain a base vector data, traversing a vector database to calculate similarities between the base vector data and each reference vector data in the vector database sequentially, determining a target reference vector data based on a maximum similarity, generating a deployment role based on the target reference vector data, invoking and running a deployment program corresponding to the deployment role. A resource allocation efficiency of a cloud platform can be improved and a resource allocation cost can be reduced.

### CROSS-REFERENCE TO RELATED APPLICATIONS

This application claims priority to Chinese Patent Application No. 202311616023.0 filed on Nov. 29, 2023, in China National Intellectual Property Administration, the contents of which are incorporated by reference herein.

### FIELD

The subject matter herein generally relates to cloud platform technology field, and more particularly to a method and a device for resource allocation of a cloud platform.

### BACKGROUND

In an application scenario of resource allocation of a cloud platform, deploying a new system or an application service needs complex setup processes. These processes may involve installing an operating system, setting up network, and installing and configuring a software application. However, a deployment method usually requires engineers to invest a lot of time and effort in manual configuration and which is repeated in each deployment. Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is a flowchart of a method for resource allocation of a cloud platform provided by an embodiment of the present disclosure.

FIG. 2 is a schematic structural diagram of a device for resource allocation of a cloud platform provided by an embodiment of the present disclosure.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts have been exaggerated to better show details and features of the present disclosure.

Several definitions that apply throughout this disclosure will now be presented.

The term “coupled” is defined as connected, whether directly or indirectly through intervening components, and is not necessarily limited to physical connections. The connection may be such that the objects are permanently connected or releasably connected. The term “comprising,” when utilized, means “including, but not necessarily limited to”; it specifically indicates open-ended inclusion or membership in the so-described combination, group, series, and the like.

In this embodiment, a method and a device for resource allocation of a cloud platform are provided to improve an efficiency of resource allocation.

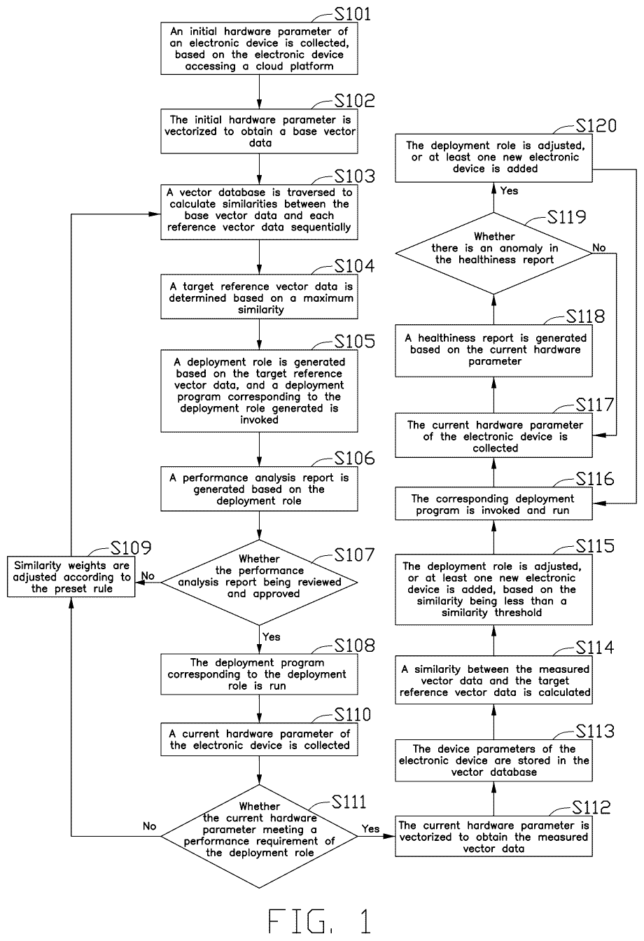

FIG. 1 is a flowchart of a method for resource allocation of a cloud platform. As shown in FIG. 1, the method includes the following blocks.

At block S101, an initial hardware parameter of an electronic device is collected, based on the electronic device accessing a cloud platform.

In block S101, the hardware parameter of the electronic device may include, but is not limited to, a processor parameter, a storage parameter, an input/output (I/O) parameter, a network parameter. The electronic device may include, but is not limited to, a smart phone, a tablet computer, a personal computer (PC), a workstation, a server, a personal digital assistant (PDA).

In this embodiment, the initial hardware parameter of the electronic device may be collected through querying a factory information of the electronic device. The factory information is used to record the initial hardware parameter of the electronic device at the time of manufacture. The factory information of the electronic device is usually stored in a memory of the electronic device.

In other embodiments, the initial hardware parameter of the electronic device may be collected through a lightweight operating system. The lightweight operating system is deployed in the electronic device. The lightweight operating system is an operating system with a minimal reliance on a hardware environment and supports viewing the hardware parameter via a web page of a browser.

At block S102, the initial hardware parameter is vectorized to obtain a base vector data.

In this embodiment, the initial hardware parameter may be vectorized through an Artificial Intelligence (AI) model. Specifically, the AI model converts a hardware parameter into a form of a mathematical vector. In this embodiment, vectorizing process may include, but is not limited to, selecting and extracting a feature, numericizing the feature, and constructing a vector of the feature.

At block S103, a vector database is traversed to calculate similarities between the base vector data and each reference vector data sequentially.

In this embodiment, the vector database is used to store device parameters of the electronic device previously accessed the cloud platform. The device parameters of the electronic device include, but are not limited to, a device identifier, a deployment role, and a vector data. The device identifier may include, but is not limited to, a device name, a device type, a device serial number, and a device identification code. In this embodiment, one device identifier corresponds to one reference vector data.

In this embodiment, a deployment role may include a controlling node, a computing node, a network node, and a storage node. The controlling node is used to manage and coordinate various services of the cloud platform. The services may include, for example, an user authentication, an image management, a network management, a virtual machine scheduling, and a resource allocation. The computing node is used to provide computing resources for virtual machines. The network node is used to provide network resources for the virtual machines. The storage node is used to provide storage resources for the virtual machines.

In this embodiment, functional characteristics of each deployment role determines that different deployment role has different requirement for a hardware environment. For example, the controlling node has a higher requirement for each hardware parameter of an electronic device. The computing node has a higher requirement for a processor parameter of an electronic device. The network node has a higher requirement for a network parameter of an electronic device. The storage node has a higher requirement for a storage parameter of an electronic device.

In this embodiment, the similarities may be calculated using a K-Nearest Neighbor (KNN) algorithm or an Approximate Nearest Neighbor (ANN) algorithm. The larger the value of the similarity, the more similar the two vectors are.

At block S104, a target reference vector data is determined based on a maximum similarity.

In this embodiment, one of the reference vector data corresponding to a maximum similarity is determined as the target reference vector data.

At block S105, a deployment role is generated based on the target reference vector data, and a deployment program corresponding to the deployment role generated is invoked.

In this embodiment, each reference vector data in a vector database has a deployment role and a deployment program. Then, when the deployment role is generated, the deployment role may be retrieved from the vector database and a deployment program corresponding to the deployment role will be invoked based on the deployment role retrieved.

At block S106, a performance analysis report is generated based on the deployment role.

In this embodiment, the performance analysis report may include that whether the initial hardware parameter meets a performance requirement of the deployment role. For example, a performance requirement of a controlling node may include, a processor parameter being greater than or equal to a first processor threshold, a storage parameter being greater than or equal to a first storage threshold, a I/O parameter being greater than or equal to a first I/O threshold, and a network parameter being greater than or equal to a first network threshold. A performance requirement for a computing node may include, a processor parameter being greater than or equal to a second processor threshold. A performance requirement for a network node may include, a network parameter being greater than or equal to a second network threshold. A performance requirement for a storage node may include a storage parameter being greater than or equal to a second storage threshold.

In this embodiment, each parameter threshold may be set as desired.

At block S107, whether the performance analysis report being reviewed and approved is determined.

In this embodiment, the performance analysis report needs to be reviewed to avoid inconsistencies between the deployment role and user requirements.

In this embodiment, the performance analysis report may be reviewed manually. In other embodiments, the performance analysis report may be reviewed through matching with a user requirement report pre-stored. The user requirement report may include a hardware parameter requested by the user.

In block S107, when the performance analysis report is reviewed and approved, a command indicating approval is triggered and block S108 is implemented.

When the performance analysis report is reviewed failed, a command indicating failure is triggered and block S109 is implemented.

In this embodiment, the command indicating approval is used to instruct to execute a corresponding deployment program. The command indicating failure is used to instruct to adjust a similarity weighting according to a preset rule.

At block S108, the deployment program corresponding to the deployment role is run.

In this embodiment, a deployment program is associated with a deployment role. The deployment program may be stored in a cloud platform database.

At block S109, similarity weights are adjusted according to the preset rule and block 103 is implemented.

In this embodiment, each deployment role has a different degree of importance. More important roles are assigned higher weight values and less important roles are assigned smaller values. Thus, the similarity weights can be adjusted according to a priority order of the deployment roles. For example, a deployment role with a higher priority can be assigned with a higher weight value, so that a calculated similarity can accurately reflect the user needs.

At Block S110, a current hardware parameter of the electronic device is collected.

In this embodiment, the current hardware parameter is used to reflect an actual operating state of the electronic device.

In this embodiment, the current hardware parameter is associated with the deployment role. For example, when the deployment role of the electronic device is the controlling node, the current hardware parameter may include a processor parameter, a storage parameter, a I/O parameter, and a network parameter. When the deployment role of the electronic device is the computing node, the current hardware parameter may include a processor parameter. When the deployment role of the electronic device is the network node, the current hardware parameter may include a network parameter. When the deployment role of the electronic device is the storage node, the current hardware parameter may include a storage parameter.

In this embodiment, the current hardware parameter of the electronic device can be collected by the lightweight operating system.

At block S111, whether the current hardware parameter meeting a performance requirement of the deployment role is determined.

In this embodiment, the current hardware parameter of the electronic device may deviate from the initial hardware parameter due to the influence of some factors. These factors include, but are not limited to, a usage environment and a durability of the device. Then, through assessing whether the current hardware parameter meeting the performance requirement of the deployment role, whether the electronic device being compatible with the current deployment role can be more accurately reflected.

In this embodiment, when the current hardware parameter meets the performance requirement of the deployment role, the current deployment role of the electronic device is maintained, and a measured vector data corresponding to the current hardware parameter is stored, and then block S112-S119 are implemented.

When the current hardware parameter does not meet the performance requirement of the deployment role, block S109 is implemented. That is, the similarity weights in accordance with a preset rule are adjusted, the deployment role is rematched to be compatible with the current hardware parameter.

At block S112, the current hardware parameter is vectorized to obtain the measured vector data.

At block S113, the device parameters of the electronic device are stored in the vector database.

As described above, the device parameters can include, but are not limited to, the device identifier, the deployment role, and the measured vector date.

In this embodiment, the more associated data of each electronic device stored in the vector database, the higher the accuracy of matching the deployment role. In addition, the more associated data of each electronic device stored in the vector database, the higher the requirement for the storage capacity of the vector database.

In this embodiment, since a storage capacity of the vector database is limited, a corresponding storage management mechanism may be set up. For example, when the storage capacity of the vector database exceeds a capacity threshold, part of the data can be deleted according to a preset rule. In this embodiment, the preset rule can include, but is not limited to, the importance level of the data or an order of the storage time of the data.

At block S114, a similarity between the measured vector data and the target reference vector data is calculated.

In block S114, calculating the similarity can be referred to the relevant description of block S103 and will not be repeated herein.

At block S115, the deployment role is adjusted, or at least one new electronic device is added, based on the similarity being less than a similarity threshold.

In this embodiment, when the similarity between the measured vector data and the target reference vector data is less than a similarity threshold, which indicates that the deviation between the measured vector data and the target reference vector data is large, that is, the measured vector data does not match the current deployment role. Then, the deployment role needs to be adjusted to be compatible with the measured vector data.

In this embodiment, when the measured vector data does not match all the deployment roles, which indicates that the electronic device is not available. Then, at least one new electronic device needs to be added.

At block S116, the corresponding deployment program is invoked and run.

In this embodiment, adjusting the deployment role or adding at least one new electronic device results in an update to the deployment program.

At block S117, the current hardware parameter of the electronic device is collected.

In block S117, collecting the current hardware parameter can be referred to the relevant description of block S110 and will not be repeated herein.

At block S118, a healthiness report is generated based on the current hardware parameter.

In this embodiment, the healthiness report may include an actual operating state of the electronic device. The actual operating state may include a normal state or an abnormal state. In this embodiment, when the current hardware parameter meets the performance requirement of the deployment role, the actual operating state is the normal state. When the current hardware parameter does not meet the performance requirement of the deployment role, the actual operating state is the abnormal state.

At Block S119, whether there is an anomaly in the healthiness report is determined.

In this embodiment, when the actual operating state of the electronic device is the abnormal state, an anomaly value is generated in the healthiness report. The anomaly value may be set as desired. Then, whether the healthiness report being abnormal can be determined through querying whether the healthiness report having the anomaly value.

In this embodiment, if there is an anomaly in the healthiness report, which indicates that the current hardware parameter does not match the current deployment role, and block S120 is implemented.

If there is no anomaly in the healthiness report, which indicates that the current hardware parameter is compatible with the current deployment role, and the current deployment role of the electronic device is maintained and block S117 is implemented.

At block S120, the deployment role is adjusted, or at least one new electronic device is added.

In this embodiment, the method includes generating a compatible deployment role based on the hardware parameter of the electronic device, invoking and running the deployment program, thereby a resource allocation efficiency can be enhanced and a resource allocation cost is reduced.

In addition, the performance analysis report is used to check whether the deployment role is compatible with the user's needs, thereby the accuracy of the resource allocation can be enhanced. Considering that the hardware parameter may be affected by the usage environment, durability of the device and other factors, the electronic device being compatible with the current deployment role can be ensured through checking whether the current hardware parameter meets the performance requirement of the deployment role.

Moreover, when the measured vector data corresponding to the current hardware parameter deviates significantly from the target reference vector data, the deployment role is adjusted or at least one new electronic device is added, thereby the accuracy of resource allocation can be ensured. As well, the healthiness report is used to check whether the actual operating state of the electronic device is abnormal, thereby whether the deployment role needs be adjusted or at least one new electronic device needs to be added can be determined, thereby the resource allocation can be optimized.

In other embodiments, the plurality of blocks described above may be combined with each other. For example, in one embodiment, blocks S101 to S105 and S108 are implemented, and other blocks may be omitted.

In another embodiment, blocks S101 to S109 are implemented, and other blocks may be omitted.

In another embodiment, blocks S101 to S105 and S108 to S113 are implemented, and other blocks may be omitted.

In another embodiment, blocks S101 to S105 and S108 to S112 and S114 to S116 are implemented, and other blocks may be omitted.

In another embodiment, blocks S101 to S105 and S108 and S117 to S118 are implemented, and other blocks may be omitted.

In another embodiment, blocks S101 to S105 and S108 and S117 to S120 are implemented, and other blocks may be omitted.

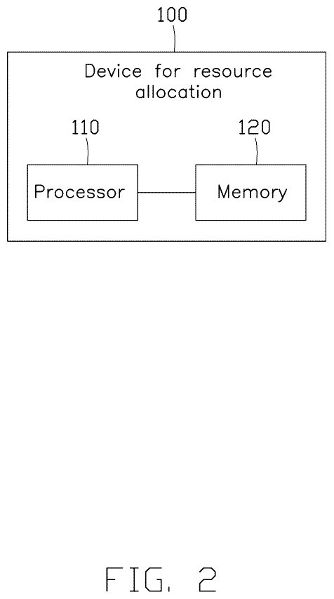

FIG. 2 is a schematic structural diagram of a device for resource allocation of a cloud platform. As shown in FIG. 2, the device 100 includes at least one processor 110, a memory 120.

The memory 120 is used to store a computer program. The computer program can be executed by the at least one processor 110 to achieve the method described above, which is not repeated here.

The processor 110 may be, but is not limited to, a central processing unit (CPU), a general-purpose processor, a digital signal processor (DSP), an application-specific integrated circuit (ASIC), a field-programmable gate array (FPGA) or another programmable logic device, a discrete gate or transistor logic device, a discrete hardware component. The general-purpose processor may be a microprocessor or any conventional processor.

In some embodiments, the memory 120 may be an internal storage unit of the device 100, such as a hard disk or a memory of the device 100. In other embodiments, the memory 120 may also be an external storage device of the device 100, such as a plug-in hard disk, a smart memory card (SMC), a secure digital (SD) card, a flash card. Further, the memory 120 may also include both an internal storage unit of the device 100 and an external storage device. The memory 120 is used to store an operating system, a disclosure program, and other programs, such as the program code of the computer program. The memory 120 may also be used to temporarily store data that has been output or is to be output.

The computer program includes computer program codes, and the computer program codes can be in a form of source codes, object codes, or an executable file.

The present disclosure further providing a computer-readable storage medium, the computer-readable storage medium is used to store a computer program. The computer program can be executed by a processor to achieve the method described above, which is not repeated here.

The computer-readable medium may include a read-only memory (ROM), a random access memory (RAM), a USB flash drive, a mobile hard disk, a magnetic disk or an optical disk.

The above description only describes embodiments of the present disclosure, and is not intended to limit the present disclosure, various modifications and changes can be made to the present disclosure. Any modifications, equivalent substitutions, improvements, etc. made within the spirit and scope of the present disclosure are intended to be included within the scope of the present disclosure.

What is claimed is:

1. A method for resource allocation of a cloud platform, comprising:
collecting an initial hardware parameter of an electronic device based on the electronic device accessing the cloud platform;
vectorizing the initial hardware parameter to obtain a base vector data;
traversing a vector database to calculate similarities between the base vector data and each reference vector data in the vector database sequentially;
determining a target reference vector data based on a maximum similarity;
generating a deployment role based on the target reference vector data; and
invoking and running a deployment program corresponding to the deployment role.

2. The method of claim 1, further comprising:
generating a performance analysis report based on the deployment role;
running the deployment program based on the performance analysis report being reviewed and approved,
wherein the performance analysis report comprises whether the initial hardware parameter meets a performance requirement of the deployment role.

3. The method of claim 2, wherein the initial hardware parameter comprises a processor parameter, a storage parameter, a input/output parameter, and a network parameter,
the deployment role comprises a controlling node, a computing node, a network node, and a storage node;
wherein the initial hardware parameter is determined to meet the performance requirement of the deployment role through any one of:
the processor parameter being greater than or equal to a first processor threshold, the storage parameter being greater than or equal to a first storage threshold, the input/output parameter being greater than or equal to a first input/output threshold, and the network parameter being greater than or equal to a first network threshold;
the processor parameter being greater than or equal to a second processor threshold;
the network parameter being greater than or equal to a second network threshold; and
the storage parameter is greater than or equal to a second storage threshold.

4. The method of claim 2, further comprising:
adjusting similarity weights according to a preset rule, based on the performance analysis report being reviewed failed;
re-determining the target reference vector data corresponding to the maximum similarity.

5. The method of claim 4, wherein adjusting similarity weights according to the preset rule comprises:
assigning a higher weight value to a higher prioritized deployment role in order of priority of each deployment role.

6. The method of claim 1, after running the deployment program, the method further comprising:
collecting a current hardware parameter of the electronic device;
determining whether the current hardware parameter meets a performance requirement of the deployment role;
vectorizing the current hardware parameter, based on the current hardware parameter being met the performance requirement of the deployment role, to obtain a measured vector data;
storing the device parameters of the electronic device in the vector database;
wherein the device parameters comprise a device identifier, the deployment role, and the measured vector date.

7. The method of claim 6, further comprising:
adjusting similarity weights according to the preset rule, based on the current hardware parameter does not meet the performance requirement of the deployment role;
re-determining the target reference vector data corresponding to the maximum similarity.

8. The method of claim 6, further comprising:
calculating a similarity between the measured vector data and the target reference vector data;
executing any one of adjusting the deployment role and adding at least one electronic device, based on the similarity being less than a similarity threshold;
invoking and running the deployment program.

9. The method of claim 1, further comprising:
collecting a current hardware parameter of the electronic device;
generating a healthiness report, based on the current hardware parameter;
wherein the healthiness report comprises an actual operating state of the electronic device, the actual operating state comprises a normal state and an abnormal state.

10. The method of claim 9, further comprising:
executing any one of adjusting the deployment role and adding at least one electronic device, based on the healthiness report having an anomaly;
invoking and running the deployment program.

11. A device for resource allocation of a cloud platform, the device comprising: a non-transitory memory storage;
at least one processor; and
at least one computer program stored in the non-transitory memory storage, which when executed by the at least one processor, cause the at least one processor to:
collect an initial hardware parameter of an electronic device based on the electronic device accessing to the cloud platform;
vectorize the initial hardware parameter to obtain a base vector data;
traverse a vector database to calculate similarities between the base vector data and each reference vector data in the vector database sequentially;
determine a target reference vector data based on a maximum similarity;
generate a deployment role based on the target reference vector data; and
invoking and running a deployment program corresponding to the deployment role.

12. The device of claim 11, the at least one processor is further configured to:
generate a performance analysis report based on the deployment role;
run the deployment program based on the performance analysis report being reviewed and approved,
wherein the performance analysis report comprises whether the initial hardware parameter meets a performance requirement of the deployment role.

13. The device of claim 12, wherein the initial hardware parameter comprises a processor parameter, a storage parameter, a input/output parameter, and a network parameter;
the deployment role comprises a controlling node, a computing node, a network node, and a storage node;
wherein the initial hardware parameter is determined to meet the performance requirement of the deployment role through any one of:
the processor parameter being greater than or equal to a first processor threshold, the storage parameter being greater than or equal to a first storage threshold, the input/output parameter being greater than or equal to a first input/output threshold, and the network parameter being greater than or equal to a first network threshold;
the processor parameter being greater than or equal to a second processor threshold;
the network parameter being greater than or equal to a second network threshold;
the storage parameter being greater than or equal to a second storage threshold.

14. The device of claim 12, the at least one processor is further configured to:
adjust similarity weights according to a preset rule based on the performance analysis report being reviewed failed;
re-determining the target reference vector data corresponding to the maximum similarity.

15. The device of claim 14, wherein adjust similarity weights according to the preset rule comprises:
assigning a higher weight value to a higher prioritized deployment role in order of priority of each deployment role.

16. The device of claim 11, after running the deployment program, the at least one processor is further configured to:
collect a current hardware parameter of the electronic device;
determine whether the current hardware parameter meets a performance requirement of the deployment role;
vectorize the current hardware parameter based on the current hardware parameter being met the performance requirement of the deployment role to obtain a measured vector data;
store the device parameters of the electronic device in the vector database;
wherein the device parameters comprise a device identifier, the deployment role and the measured vector data.

17. The device of claim 16, the at least one processor is further configured to:
adjust similarity weights according to the preset rule, based on the current hardware parameter does not meet the performance requirement of the deployment role;
re-determine the target reference vector data corresponding to the maximum similarity.

18. The device of claim 16, the at least one processor is further configured to:
calculate a similarity between the measured vector data and the target reference vector data;
execute any one of adjusting the deployment role and adding at least one electronic device, based on the similarity being less than a similarity threshold;
invoking and running the deployment program.

19. The device of claim 11, the at least one processor e is further configured to:
collect a current hardware parameter of the electronic device;
generate a healthiness report based on the current hardware parameter;
wherein the healthiness report comprises an actual operating state of the electronic device, the actual operating state comprises a normal state and an abnormal state.

20. The device of claim 19, the at least one processor is further configured to:
execute any one of adjusting the deployment role and adding at least one electronic device based on the healthiness report having an anomaly;
invoking and running the deployment program.
